(19) United States
(12) Patent Application Publication
(10) Pub. No.: US 2022/0125067 A1
(43) Pub. Date: Apr. 28, 2022

(54) COFFEE PULP EXTRACT AND PRODUCTION METHOD

(71) Applicant: INDUSTRIA COLOMBIANA DE CAFE S.A.S., Medellín (CO)

(72) Inventors: Nelsón Jairo TABORDA VALENCIA, Medellín (CO); Mauricio NARANJO CANO, Medellín (CO)

(21) Appl. No.: 17/296,353

(22) PCT Filed: Sep. 27, 2018
(86) PCT No.: PCT/IB2018/057523

§ 371 Date: May 24, 2021

(30) Foreign Application Priority Data
Sep. 27, 2017 (CO) NC2017/0009721

(51) Int. Cl. A23F 5/18; A23F 5/28

(52) U.S. Cl. CPC A23F 5/18; A23F 5/28

(57) ABSTRACT

The present invention discloses a method for the preparation of an extract from coffee pulp comprising mechanically extracting, filtering and concentrating fresh pulp at conditions of pressure and temperature. It further claims an extract from coffee pulp characterized by having a total percentage of sugars between 8 and 20%, a percentage of ash less than 20%, insoluble fiber between 0.01 and 1.00%, soluble fiber between 15.0 and 40.0%, moisture less than 20% and caffeine between 0.5 and 5.0%.

### TECHNICAL FIELD OF THE INVENTION

The present invention relates to methods for preparing coffee extracts; having its main application in the coffee industry field. Particularly, the invention refers to a method for obtaining a coffee pulp extract.

### BACKGROUND

The cherry or fruit of the coffee tree must be submitted to different processes to obtain the dry seed that is the raw material in the production of roasted coffee and instant coffee. There are several methods to obtain this seed, among them the dry and wet methods, each one generating different sensory characteristics in the prepared beverages.

In the wet process the coffee seed is separated from the co-products. The process begins by separating the first co-product, which is the fruit husk, also called pulp, using a pulper. Then the mucilage is removed and finally the husk is separated in the threshing process.

One of the current objectives of the industry is to be able to use these co-products for human consumption. As mentioned above, one of these co-products is pulp, which is a potential source of antioxidants, phenolic products, caffeine, carbohydrates, fiber, among others. Since the pulp at the pulper output has a moisture content between 70 and 85%, it has a high probability of mycotoxin occurrence, so it is necessary to process it in the shortest possible time. The prior art in general suggests the use of pulp rapid drying, in particular through the use of dryers with hot air flow to obtain a final moisture content of less than 20%, making it necessary to use solvents such as water or extraction at high temperatures to obtain the soluble solids present in the pulp.

Different techniques or methods for obtaining extracts from different co-products of the coffee industry are found in the prior art. For example, patent document WO2014149512 discloses a method for preparing a coffee extract comprising an extraction of the previously reduced coffee pulp particles; said extraction is carried out in water by mechanical methods such as ultrasonic extraction, followed by extract filtration; particularly by membrane to finally concentrate the liquid extract.

On the other hand, patent document WO2013003004873 refers to a method for elaborating a coffee extract based mainly on extraction with preferably subcritical water at temperatures between 50 and 200° C. and constant pressure between 69 and 207 bars. Such extraction may take place by enzymatic hydrolysis, cell rupture using mechanical procedures at room temperature or extraction with hot or supercritical water.

The present development proposes another alternative for obtaining pulp extract without the need to dry it before the extraction process. This is important considering that drying by exposure to the environment, i.e., without the use of drying equipment, presents a high risk of pulp contamination by domestic animals and insects, as well as by pulp fermentation due to careless drying. Furthermore, the present invention does not require water in the extraction process, given the high humidity contained in the fresh pulp.

### BRIEF SUMMARY OF THE INVENTION

The present invention is directed to a method for the elaboration of a coffee pulp extract, as well as the pulp extract obtained in said process. In particular, the method comprises a mechanical extraction of fresh pulp between 50 (5000 KPa) and 1000 bar (10000 KPa) or between 1000 and 8000 rpm, leachate filtration to remove insoluble solids and finally a concentration to a soluble solids content between 15% and 95% wet basis.

### DETAILED DESCRIPTION OF THE INVENTION

The present invention relates to a method for obtaining a coffee extract by means of a mechanical extraction at the outlet of the pulper, a material filtration and a subsequent concentration, and the coffee extract obtained.

The process of the present invention begins after the pulping process. “Pulping” refers to a process in which the coffee husk or pulp is separated from the seed by a mechanical process, using equipment such as a pulper. The seed continues in a process of separation of mucilage and parchment seed, and the wet pulp is taken to storage.

The fresh coffee pulp, coffee pulp or wet pulp, which is subsequently stored in a silo, is fed to an equipment to start the process of obtaining coffee pulp extract. The fresh pulp has a humidity between 65 and 85% or between 70 and 95%.

TABLE 1
Properties of fresh (wet) and dehydrated (dry) pulp

| Parameter | Fresh | Dehydrated |
|---|---|---|
| Humidity [%] | 65.0-85.0 | 5.0-15.0 |
| Dry material [%] | 20.0-40.0 | 70.0-90.0 |
| Crude fiber [%] | 1.0-10.0 | 10.0-30.0 |
| Crude protein [%] | 1.0-10.0 | 8.0-15.0 |
| Ashes [%] | 0.5-5.0 | 7.0-10.0 |
| Free Nitrogen Extract [%] | 5.0-20.0 | 35.0-50.0 |

In one embodiment of the invention, before entering the extraction stage, the particle size of the fresh coffee pulp is reduced to change the solid appearance of the pulp to a liquid phase that facilitates feeding the material to the extraction process, as part of an optional adaptation of the material. Particularly it is reduced to a size between 300 and 1000 microns. Particle size reduction may be accomplished by any method known to a person moderately skilled in the art.

The process of the present invention to obtain a coffee pulp extract begins with mechanically extracting a leachate from a coffee pulp. In this stage, the fresh pulp is passed through an equipment or machine that through pressure or high speed, is in charge of separating the leachate with the soluble solids from the insoluble material.

The mechanical extraction equipment may be fed at any feed rate, nut opening or nozzle size according to the desired requirements and the knowledge of a person moderately versed in the technique. Mechanical extraction occurs at a pressure between 50 bar (5000 KPa) and 1000 bar (10000 KPa), between 300 bar (30000 KPa) and 500 bar (50000 KPa), or between 200 bar (20000 KPa) and 800 bar (80000 KPa). On the other hand, mechanical extraction has a high speed, where high speed is understood as a speed between 1000 and 8000 rpm, between 3000 rpm and 6000 rpm or between 4000 rpm and 5000 rpm.

In general, after the extraction stage, the humidity of the original coffee pulp is reduced (as explained previously) until a leachate is obtained having a humidity between 50% and 70%, or between 55 and 75%. The leachate obtained after this stage has a concentration of soluble solids between 5% and 30% wet basis, between 10% and 35% wet basis or between 8% and 20% wet basis.

The mechanical extraction stage of the present invention does not involve solvents, nor a drying stage of the pulp before entering the process. In particular, the mechanical extraction of the present invention does not use water.

The extraction stage is followed by a filtration stage, where the leachate obtained in the previous stage is filtered to remove insoluble solids, until a clarified leachate is obtained. A clarified leachate is one characterized by having a concentration of insoluble solids of less than 5.0% dry basis, less than 4.0% dry basis, less than 3.0% dry basis, or less than 2.0% dry basis.

Subsequently the clarified leachate is concentrated, for example by subjecting it to a temperature between 35° C. (308K) and 75° C. (348K), between 45° C. (318K) and 58° C. (331K), between 40° C. (313K) and 70° C. (343K), and/or an absolute pressure between 30 mbar (3000 Pa) and 100 mbar (10000 Pa), or pressure conditions between 80 mbar (8000 Pa) and 120 mbar (12000 Pa), between 85 mbar (8500 Pa) and 105 mbar (10500 Pa) until a coffee pulp extract is obtained. Or by cold methods at a temperature between −15° C. (258K) and −1° C. (272K), or any concentration method known by a person moderately versed in the matter. The clarified leachate is concentrated to a soluble solids content between 15% and 95% wet basis, between 30% and 80% wet basis or between 20% and 50% wet basis.

Optionally, after the concentration stage, a pasteurization or ultra-pasteurization stage is carried out to destroy microorganisms without altering the composition and qualities of the coffee pulp extract.

Optionally, the coffee pulp extract is dried by any technique known to a person moderately versed in the matter, such as spray drying or lyophilization. In order to preserve the product properties, it is suggested that the drying stage occurs at a temperature between 100° C. and 300° C., between 100° C. and 150° C. or between 110° C. and 180° C., where the coffee pulp extract has a moisture content of no more than 20%, no more than 15% or no more than 10%.

The coffee pulp extract obtained has a high solids content, i.e., a concentration of soluble solids between 20% and 45% or the following composition:

TABLE 2
Coffee pulp extract characteristics

| Parameter | Dry powder |
|---|---|
| Total sugars [%] | 8.0-20.0 |
| Calories [cal/100 g] | 200-500 |
| Carbohydrates [%] | 40-100 |
| Ashes [%] | <20 |
| Cholesterol [mg/100 g] | <2.0 |
| Insoluble Fiber [%] | 0.01-1.00 |
| Soluble Fiber [%] | 15-40% |
| Humidity [%] | <10 |
| Caffeine [%] | 0.5-5.0 |

Optionally, the coffee pulp extract is also mixed with coffee extract (obtained from the extraction of the green or roasted seed). Optionally, in order to give it greater stability, the coffee pulp extract may be in powder or freeze-dried form.

After drying the coffee pulp extract, the extract has the following characteristics:

TABLE 3
Characteristics of the coffee pulp extract after drying

| Parameter | Dry powder |
|---|---|
| Free-fall density [g/L] | 150-350 |
| Humidity [%] | <10 |
| Color Hunter Lab L* | 20-50 |
| Sediment [%] | <5 |
| pH | 4.0-6.0 |

Optionally, the coffee pulp extracts are microbiologically stabilized by a pasteurization or ultra-pasteurization process.

Pulp extracts are used in: pulp extract (concentrated and unconcentrated) (also in powder, agglomerated and freeze-dried), hydrolyzed extract (also in powder, agglomerated and freeze-dried), extract with mixtures of fruit extracts (also in powder, agglomerated and freeze-dried), extract with mixed mucilage (also in powder, agglomerated and freeze-dried), extract with blended liquid and powder coffee (also powdered, agglomerated and freeze-dried), extract blended with flavors and essences (also powdered, agglomerated and freeze-dried), powdered, freeze-dried and granulated pulp extract, powdered pulp extract blended with non-dairy creamer and sugar, powdered pulp extract in capsule and Ready-To-Drink (RTD) drinks of all the aforesaid.

By coffee extract, the present invention refers to coffee pulp, wet coffee pulp, coffee, coffee cherry, coffee fruit, coffee cherry skin, husk or exocarp. Specifically, it refers to coffee husk or coffee pulp. For purposes of the present invention “coffee pulp” refers to “coffee husk”.

The following Examples illustrate the invention, without the inventive concept being restricted thereto:

### EXAMPLES

### Example 1: The Pulp Used in the Following Examples has the Following Composition

TABLE 4
Fresh pulp composition

| Parameter | Fresh |
|---|---|
| Humidity [%] | 77.5 |
| Dry material [%] | 22.5 |
| Crude fiber [%] | 3.4 |
| Crude protein [%] | 2.1 |
| Ashes [%] | 1.5 |
| Free Nitrogen Extract [%] | 15.8 |

### Example 2: Pulp Extract by High-Pressure Extraction and Concentration by Evaporation

Mechanically Extract a Leachate from a Coffee Pulp.

A coffee pulp was obtained from a pulping process, where the wet pulp had a humidity percentage of 77.5%. Then, 100 kg of pulp were fed into the hopper of an extruder at a speed of 10 kg/hour. The extruder had a nut opening of 1.6 mm, an internal pressure of 400 bar (40000 KPa) and a nozzle number 10. As the pulp passed through the extruder screw, 41 kg of leachate was extracted from the coffee pulp with a concentration of 15% soluble solids. At the exit of the equipment, a pulp with a moisture content of 62% is obtained.

Filter the leachate obtained in the previous stage to remove insoluble solids until a clarified leachate is obtained.

The coffee pulp leachate was centrifuged at a speed of 4000 rpm for 5 minutes to remove or separate insoluble solids. A clarified leachate with an insoluble solids concentration of 5000 ppm was obtained.

Concentrate the clarified leachate obtained in the previous stage until a coffee pulp extract is obtained.

The clarified leachate was fed to an evaporator at 50° C. (323K) temperature and an absolute pressure of 90 mbar (9000 Pa). A liquid coffee pulp extract was obtained with a concentration of 35% s.s. The liquid pulp extract was spray dried at 120° C. (393K). A powder with a moisture content of 3% was obtained.

TABLE 5
Pulp extract composition of Example 2.

| Parameter | Dry powder |
|---|---|
| Total sugars [%] | 13.0-15.0 |
| Calories [cal/100 g] | 300-350 |
| Carbohydrates [%] | 60.0-80.0 |
| Ashes [%] | <16 |
| Cholesterol [mg/100 g] | <0.05 |
| Insoluble Fiber [%] | 0.02 |
| Soluble Fiber [%] | 25.0-32.0% |
| Humidity [%] | <3 |
| Caffeine [%] | 1.5-2.2 |

### Example 3: Pulp Extract by High-Pressure Extraction and Cold Concentration

Concentrate the Clarified Leachate Obtained in the Previous Stage Until a Coffee Pulp Extract is Obtained.

From the leachate clarified in Example 2, this was fed to a cold concentration equipment at a temperature of −4° C. (269K) at a rate of 35 kg/h. A liquid coffee pulp extract with a concentration of 33% s.s was obtained at a rate of 16 kg/h.

### Example 4. Pulp Extract by High-Speed Extraction and Concentration by Evaporation

Adaptation of Raw Material Pulp

A pulp was obtained from a pulping process, the wet pulp with a moisture content of 77.5%. The pulp is processed in a mechanical disc mill to reduce the particle size, until the solid appearance of the pulp changes to a liquid phase, which allows the feeding of the extraction equipment.

Mechanically Extract a Leachate from a Coffee Pulp;

Then, 50 kg of the ground pulp was manually fed into a decanter at a speed of 4500 rpm at a feed rate of 1000 kg/h for one hour. After passing the semi-liquid pulp slurry through the decanter, 15 kg of leachate was extracted from the coffee pulp with a concentration of 10% soluble solids wet basis. At the exit of the equipment, a pulp with a moisture content of 68% was obtained.

Filter the Leachate Obtained in the Previous Stage to Remove Insoluble Solids Until a Clarified Leachate is Obtained

The coffee pulp leachate was centrifuged at a speed of 4000 rpm for 5 minutes to remove or separate insoluble solids. A clarified leachate was obtained with a soluble solids concentration of 10% wet basis and an insoluble solids concentration of 1% dry basis.

Concentrate the Clarified Leachate Obtained in the Previous Stage Until a Coffee Pulp Extract is Obtained.

The clarified leachate was fed to an evaporator at 50° C. temperature and an absolute pressure of 90 mbar (9 KPa). A liquid coffee pulp extract with a concentration of 35% s.s. wet basis is obtained. An ultra-pasteurization step is performed on the liquid coffee pulp extract obtained. The liquid pulp extract was spray dried at 120° C. (393K), and a powder with a moisture content of 3% was obtained.

### Example 5. Pulp Extract by High-Speed Extraction and Cold Concentration

Concentrate the Clarified Leachate Obtained in Step (b) to Obtain a Coffee Pulp Extract.

The clarified leachate as shown in Example 1 was fed at a rate of 35 kg/h to a cold concentration equipment at a temperature of −4° C. (269K). A liquid coffee pulp extract with a concentration of 33% s.s wet basis was obtained.

### Example 6. Pulp Extract by High-Speed Extraction and Concentration by Evaporation

Mechanically Extract a Leachate from a Coffee Pulp A pulp was obtained from a pulping process, the wet pulp with a moisture content of 77.5%. Then, 1000 kg of pulp were fed to a centrifuge with a feed rate of 15,000 kg/hour. The centriflux worked at a speed of 7,500 rpm. On passing the pulp through the centrifuge, a leachate was obtained with a soluble solids concentration of 10% and insoluble solids of 5%. The amount of leachate was 400 kg.

Filter the Leachate Obtained in the Previous Stage to Remove Insoluble Solids Until a Clarified Leachate is Obtained.

The coffee pulp leachate was centrifuged at a speed of 5,500 rpm for 5 minutes to remove or separate insoluble solids. A clarified leachate was obtained with an insoluble solids concentration of 500 ppm.

Concentrate the Clarified Leachate Obtained in the Previous Stage Until a Coffee Pulp Extract is Obtained.

The clarified leachate was fed to an evaporator at 50° C. temperature and an absolute pressure of 90 mbar. A liquid coffee pulp extract is obtained with a concentration of 35% s.s. The liquid pulp extract was spray dried at 120° C. A powder with a moisture content of 3% was obtained.

1. A method for obtaining coffee pulp extract, comprising:
a) mechanically extracting a leachate from a coffee pulp;
b) filtering the leachate obtained in step (a) to remove insoluble solids until a clarified leachate is obtained;
c) concentrating the clarified leachate obtained in step (b) to obtain a coffee pulp extract.

2. The method according to claim 1, wherein in stage (a) the coffee pulp is characterized by having a moisture content between 65% and 85%, dry matter between 20.0 and 30.0%, crude fiber 1.0 and 3.0%, crude protein between 1.0 and 3.0%, ash 0.5 and 2.0%, and nitrogen free extract between 5.0 and 10.0%.

3. The method according to claim 1, wherein in step (a) the mechanical extraction occurs between 50 and 1000 bar.

4. The method according to claim 1, wherein in step (a) the mechanical extraction occurs at a speed between 1000 and 8000 rpm.

5. The method according to claim 1, wherein the leachate obtained in step (a) is characterized by having a soluble solids content between 5% and 30% wet basis.

6. The method according to claim 1, wherein the clarified leachate from step (b) is characterized by having an insoluble solids concentration of less than 20% dry basis.

7. The method according to claim 1, wherein in step (c) the clarified leachate is concentrated to a soluble solids content between 15% and 95% wet basis.

8. The method according to claim 1, wherein optionally after step (c) a pasteurization or ultra-pasteurization step is performed.

9. The method according to claim 1, wherein optionally after step (c) a drying step occurs characterized in that a coffee pulp extract with a moisture content not exceeding 10% is obtained.

10. A coffee pulp extract characterized by:

| Parameter | Dry powder |
|---|---|
| Total sugars [%] | 8.0-20.0 |
| Ashes [%] | <20.0 |
| Insoluble Fiber [%] | 0.01-1.00 |
| Soluble Fiber [%] | 15.0-40.0% |
| Humidity [%] | <20.0 |
| Caffeine [%] | 0.5-5.0 |
